(19) United States
(12) Patent Application Publication
(10) Pub. No.: US 2024/0386483 A1
(43) Pub. Date: Nov. 21, 2024

(54) DIGITAL ASSET MANAGEMENT APPARATUS, DIGITAL ASSET MANAGEMENT SYSTEM, DIGITAL ASSET MANAGEMENT METHOD, AND NON-TRANSITORY COMPUTER-READABLE MEDIUM

(71) Applicant: NEC Corporation, Minato-ku, Tokyo (JP)

(72) Inventor: Tadanobu NAKAYAMA, Tokyo (JP)

(73) Assignee: NEC Corporation, Minato-ku, Tokyo (JP)

(21) Appl. No.: 18/693,183

(22) PCT Filed: Oct. 15, 2021
(86) PCT No.: PCT/JP2021/038252

§ 371 Date: Mar. 19, 2024

(51) Int. Cl. G06Q 40/02

(52) U.S. Cl. CPC G06Q 40/02

(57) ABSTRACT

An object is to provide a digital asset management apparatus capable of appropriately managing a digital asset. A digital asset management apparatus (10) according to the present disclosure includes: a registration unit (11) that registers agent information of an agent with respect to member information of a member having an account; a first transmission unit (12) that transmits a confirmation notice to the member in a case where there is no access for a setting period set by the member or more; a second transmission unit (13) that transmits an agent notice to the agent in a case where there is no member response; an authentication control unit (14) that controls authentication of the agent in a case where there is an agent response; and an authorization unit (15) that gives the agent authority related to a digital asset when the authentication is successful.

### TECHNICAL FIELD

The present disclosure relates to a digital asset management apparatus, a digital asset management system, a digital asset management method, and a non-transitory computer-readable medium.

### BACKGROUND ART

In recent years, transactions based on digital assets have been conducted in which the economic value of the assets is represented digitally. Examples of the digital asset include electronic money, an Internet bank account, crypto-assets, an account of a social networking service (SNS), and the like.

In such a digital asset, information is stored in a predetermined management server or the like in a digital format. Therefore, in a case where the owner of the digital asset dies or in a case where it is difficult for the owner to manage the digital asset, the digital asset is in a state of being not managed. In the case of a paid membership service, the fee is continuously charged until the unsubscribe procedure is completed. Further, even when a family member of the owner or the like knows the presence of the digital asset, the family member or the like may not be able to quickly take over the management of the asset because the family member or the like does not know the ID and the password.

In response to such a problem, Patent Literature 1 discloses, as a related technique, an information processing apparatus including receiving means for transmitting confirmation information for confirming whether a user is alive to a user terminal and receiving response information to the confirmation information from the user terminal. The information processing apparatus includes control means for reading asset information and identification information of a successor from a storage unit based on identification information of the user when determining that the response information has not been received within a certain period of time, and storing the asset information and the identification information of the successor in the storage unit in association with each other. With such a configuration, the information processing apparatus disclosed in Patent Literature 1 can read the information of the location of the successor and inquire whether to accept or relinquish the succession. Further, in a case where approval information indicating approval for the inquiry is received, processing related to asset succession is executed for the successor.

### CITATION LIST

### Patent Literature

Patent Literature 1: Japanese Unexamined Patent Application Publication No. 2012-248021

### SUMMARY OF INVENTION

### Technical Problem

In the technique disclosed in Patent Literature 1, in a case where the setting period until the confirmation information to the user is transmitted is long, there is no response from the user, and there is a possibility that a time has elapsed since the user has already become incapable of responding by the time when an inquiry to the successor is made. In such a case, the digital asset is in a state of being unmanaged for a long period of time. On the other hand, in a case where the setting period is short, the number of pieces of confirmation information to be transmitted to the user increases, and the user has time and effort to transmit the response information.

In view of such a problem, an object of the present disclosure is to provide a digital asset management apparatus, a digital asset management system, a digital asset management method, and a non-transitory computer-readable medium capable of appropriately managing a digital asset.

### Solution to Problem

A digital asset management apparatus according to the present disclosure includes:
registration means for registering agent information of an agent with respect to member information of a member having an account;
first transmission means for transmitting a confirmation notice to the member in a case where there is no access to the account for a setting period set by the member or more;
second transmission means for transmitting an agent notice to the agent in a case where there is no member response from the member in response to the confirmation notice;
authentication control means for controlling authentication of the agent in a case where there is an agent response from the agent in response to the agent notice; and
authorization means for giving the agent authority related to a digital asset of the member when the authentication is successful.

A digital asset management system according to the present disclosure includes:
an authentication apparatus; and
a digital asset management apparatus,
in which the digital asset management apparatus includes
registration means for registering agent information of an agent with respect to member information of a member having an account;
first transmission means for transmitting a confirmation notice to the member in a case where there is no access to the account for a setting period set by the member or more;
second transmission means for transmitting an agent notice to the agent in a case where there is no member response from the member in response to the confirmation notice;
authentication control means for controlling authentication of the agent with respect to the authentication apparatus in a case where there is an agent response from the agent in response to the agent notice; and
authorization means for giving the agent authority related to a digital asset of the member when the authentication is successful.

A digital asset management method according to the present disclosure includes:
registering agent information of an agent with respect to member information of a member having an account;
transmitting a confirmation notice to the member in a case where there is no access to the account for a setting period set by the member or more;
transmitting an agent notice to the agent in a case where there is no member response from the member in response to the confirmation notice;
controlling authentication of the agent in a case where there is an agent response from the agent in response to the agent notice; and
giving the agent authority related to a digital asset of the member when the authentication is successful.

A non-transitory computer-readable medium storing a program according to the present disclosure causes a computer to execute:
registration processing of registering agent information of an agent with respect to member information of a member having an account;
first transmission processing of transmitting a confirmation notice to the member in a case where there is no access to the account for a setting period set by the member or more;
second transmission processing of transmitting an agent notice to the agent in a case where there is no member response from the member in response to the confirmation notice;
authentication control processing of controlling authentication of the agent in a case where there is an agent response from the agent in response to the agent notice; and
authorization processing of giving the agent authority related to a digital asset of the member when the authentication is successful.

### Advantageous Effects of Invention

The present disclosure can provide a digital asset management apparatus, a digital asset management system, a digital asset management method, and a non-transitory computer-readable medium capable of appropriately managing a digital asset.

### BRIEF DESCRIPTION OF DRAWINGS

FIG. 1 is a block diagram illustrating a configuration of a digital asset management apparatus according to a first example embodiment.

FIG. 2 is a flowchart illustrating a flow of digital asset management processing according to the first example embodiment.

FIG. 3 is a block diagram illustrating a configuration of a digital asset management system according to a second example embodiment.

FIG. 4 is a block diagram illustrating a configuration of an authentication apparatus according to the second example embodiment.

FIG. 5 is a flowchart illustrating a flow of face information registration processing according to the second example embodiment.

FIG. 6 is a flowchart illustrating a flow of face authentication processing according to the second example embodiment.

FIG. 7 is a block diagram illustrating a configuration of a digital asset management apparatus according to the second example embodiment.

FIG. 8 is a diagram illustrating an example of member information according to the second example embodiment.

FIG. 9 is a diagram illustrating an example of agent information according to the second example embodiment.

FIG. 10 is a diagram illustrating an example of asset management information according to the second example embodiment.

FIG. 11 is a diagram illustrating an example of an asset management information registration screen according to the second example embodiment.

FIG. 12 is a diagram illustrating another example of an asset management information registration screen according to the second example embodiment.

FIG. 13 is a flowchart illustrating registration processing of asset management information according to the second example embodiment.

FIG. 14 is a flowchart illustrating confirmation notice transmission processing according to the second example embodiment.

FIG. 15 is a flowchart illustrating agent notice transmission processing according to the second example embodiment.

FIG. 16 is a flowchart illustrating authentication control processing and authorization processing according to the second example embodiment.

FIG. 17 is a flowchart illustrating agent confirmation processing according to the second example embodiment.

FIG. 18 is a diagram illustrating a hardware configuration example.

### EXAMPLE EMBODIMENT

Hereinafter, example embodiments of the present disclosure will be described in detail with reference to the drawings. In the drawings, the same or corresponding elements are denoted by the same reference signs, and an overlapping description is omitted as necessary for clarity of description.

### First Example Embodiment

Hereinafter, example embodiments of the present disclosure will be described with reference to the drawings.

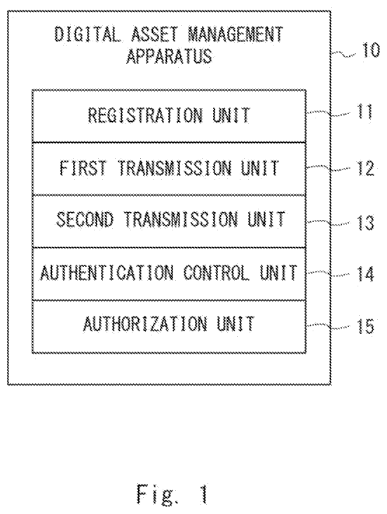

FIG. 1 is a block diagram illustrating a configuration of a digital asset management apparatus 10 according to this example embodiment. The digital asset management apparatus 10 includes a registration unit 11, a first transmission unit 12, a second transmission unit 13, an authentication control unit 14, and an authorization unit 15.

The registration unit 11 registers the agent information of an agent with respect to member information of a member having an account.

The first transmission unit 12 transmits a confirmation notice to the member when there is no access to the account for a setting period set by the member or more.

The second transmission unit 13 transmits an agent notice to the agent when there is no member response from the member in response to the confirmation notice.

The authentication control unit 14 controls authentication of the agent when there is an agent response from the agent in response to the agent notice.

In a case where the authentication is successful, the authorization unit 15 gives the agent the authority related to the digital asset of the member.

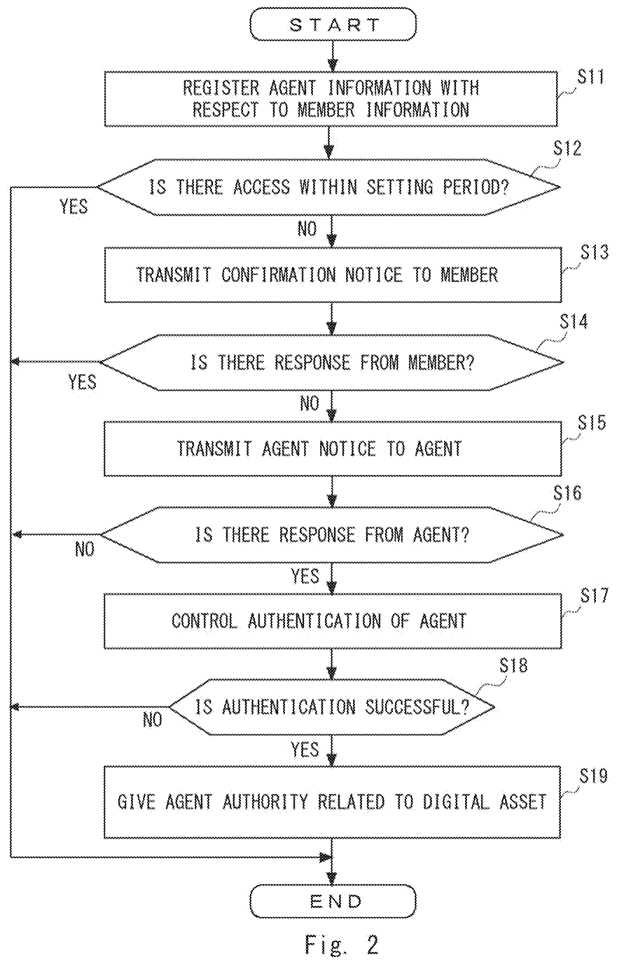

FIG. 2 is a flowchart illustrating a flow of digital asset management processing performed by the digital asset management apparatus 10 according to this example embodiment.

The registration unit 11 registers the agent information of an agent with respect to member information of a member having an account (S11). The first transmission unit 12 determines whether or not there is an access to the account within the setting period set by the member (S12). When there is an access (YES in S12), the processing ends. When there is no access (NO in S12), the first transmission unit 12 transmits a confirmation notice to the member (S13).

The second transmission unit 13 determines whether or not there is a member response from the member in response to the confirmation notice (S14). When there is a member response (YES in S14), the processing ends. When there is no member response (NO in S14), the second transmission unit 13 transmits an agent notice to the agent (S15).

The authentication control unit 14 determines whether there is an agent response from the agent in response to the agent notice (S16). When there is no agent response from the agent (NO in S16), the processing ends. When there is an agent response (YES in S16), the authentication control unit 14 controls authentication of the agent (S17). For example, the authentication control unit 14 requests an external authentication apparatus to perform biometric authentication or authentication using a password, and receives an authentication result.

The authorization unit 15 determines whether the authentication of the agent is successful (S18). When the authentication fails (NO in S18), the processing ends. When the authentication is successful (YES in S18), the authorization unit 15 gives the agent the authority related to the digital asset of the member (S19).

As described above, in a case where there is no access to the account within the setting period set by the member, the digital asset management apparatus 10 according to this example embodiment transmits the confirmation notice to the member. In a case where there is no response from the member, the digital asset management apparatus 10 transmits an agent notice to the agent. The digital asset management apparatus 10 authenticates the agent in a case where there is a response from the agent, and when the agent succeeds in authentication, the digital asset management apparatus 10 gives the agent the authority related to the digital asset of the member.

In this way, even in a case where the member has not accessed the account for the setting period or more, it is possible to appropriately manage the digital asset by giving the authority to the agent.

### Second Example Embodiment

Next, a configuration example of a digital asset management system 1000 according to the second example embodiment will be described. This example embodiment is a specific example of the first example embodiment described above.

### (Digital Asset Management System 1000)

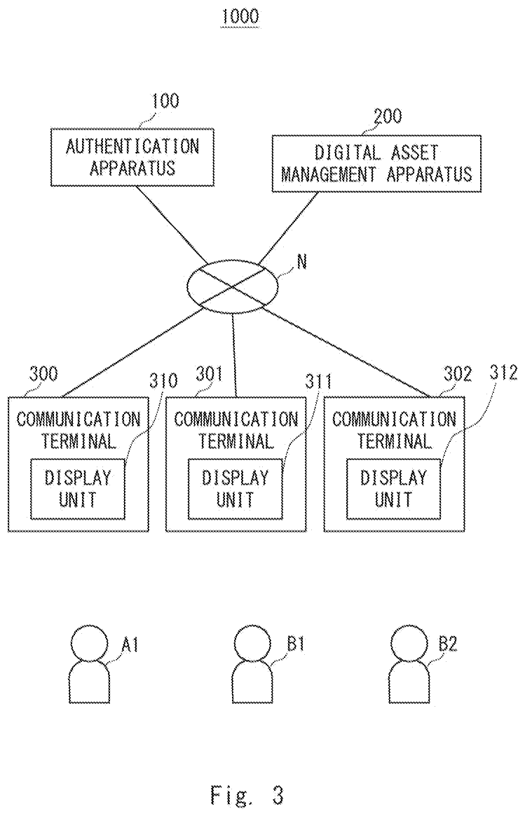

FIG. 3 is a block diagram illustrating a configuration of the digital asset management system 1000 according to this example embodiment. The digital asset management system 1000 includes an authentication apparatus 100, a digital asset management apparatus 200, a communication terminal 300, a communication terminal 301, and a communication terminal 302.

The authentication apparatus 100, the digital asset management apparatus 200, the communication terminal 300, the communication terminal 301, and the communication terminal 302 are connected via a network N. It does not matter whether the network N is wired or wireless, and any type of communication protocol may be used.

The digital asset management system 1000 registers agent information of an agent with respect to member information of a member having an account, performs predetermined determination processing in a case where there is no access by the member for a setting period or more, and gives the agent the authority related to the digital asset. The digital asset may include, for example, electronic money, a deposit in an Internet bank account, securities of online securities, or digital data such as letters, images, videos, music, or the like posted on an SNS. Further, the digital asset may include management information for managing these assets. The management information is, for example, an ID and a password for logging in to a service for using the digital asset. Accordingly, for example, an ID, a password, and the like for accessing an account of an electronic commerce (EC) site or the like used by a member can be included in the digital asset.

For example, it is assumed that a member regularly purchases a product (supplements, cosmetics, and the like) on an EC site. In a case where there is no access to the EC site by the member for a setting period or more, the agent is authorized according to predetermined determination processing. When the agent is authorized to acquire the ID and password for logging in to the EC site, the agent can use them to access the member's account. The agent stops the regular purchase of the product as necessary. In this way, even in a case where the fee is automatically paid by bank account withdrawal or the like, the use of the service can be quickly stopped. Note that the content of the digital asset is not limited thereto.

In this example embodiment, the description will be given using a case where the agent information of agents B1 and B2 is registered with respect to member information of member A1 who is a member of a service using the digital asset. Here, an example in which the agents B1 and B2 are the spouse and a child of the member A1 is used, but the relationship between the member and the agent is not limited. For example, an unrelated person may be the agent. Note that, hereinafter, the agents B1 and B2 may be collectively referred to simply as the “agent” for description. Further, the member A1 may be simply referred to as the “member” for description.

### (Communication Terminals 300 to 302)

The communication terminal 300 is a communication terminal owned by the member A1. The communication terminal 300 is, for example, an information processing apparatus such as a personal computer, a smartphone, or a tablet terminal. Not limited to these, various information processing apparatuses capable of communicating via the network N may be used for the communication terminal 300. The communication terminal 300 includes a display unit 310. The display unit 310 is at least a display apparatus. Further, the display unit 310 may be an input/output unit including a display apparatus and an input apparatus, for example, a touch panel. The member A1 registers the member information and the agent information in the digital asset management apparatus 200 using the communication terminal 300 according to a registration screen 310a displayed on the display unit 310. The communication terminal 300 receives a confirmation notice or the like transmitted from the digital asset management apparatus 200. Further, the communication terminal 300 makes a member response with respect to the confirmation notice to the digital asset management apparatus 200.

The communication terminals 301 and 302 are communication terminals owned by the agents B1 and B2, respectively. The communication terminals 301 and 302 include display units 311 and 312, respectively. Since the configuration of the communication terminals 301 and 302 is similar to that of the communication terminal 300, the description thereof will be omitted. The communication terminals 301 and 302 receive an agent notice or the like transmitted from the digital asset management apparatus 200. Further, the communication terminals 301 and 302 make an agent response with respect to the agent notice to the digital asset management apparatus 200. Furthermore, the communication terminals 301 and 302 receive an agent confirmation notice transmitted from the digital asset management apparatus 200, and make a response thereto.

### (Authentication Apparatus 100)

The authentication apparatus 100 is an information processing apparatus that performs personal authentication of the user in response to an authentication request from the digital asset management apparatus 200. Here, the user indicates the member A1, the agent B1, or the agent B2. The authentication apparatus 100 may perform authentication using an ID, a password, or the like, or may perform biometric authentication using biometric information such as a face or an iris. The authentication apparatus 100 returns an authentication result to the digital asset management apparatus 200. Further, biometric authentication may be performed on some users. For example, password authentication may be performed on the member A1, and biometric authentication may be performed on the agent B1 or B2.

Hereinafter, a configuration of the authentication apparatus 100 will be specifically described by taking a case where the authentication apparatus 100 performs biometric authentication as an example. The authentication apparatus 100 is an information processing apparatus that collates the biometric information included in a biometric authentication request received from the outside with biometric information of each user stored in advance in response to the request, and returns a collation result (authentication result) to the request source. The biometric information is feature information of biometric information used for biometric authentication. The biometric information is, for example, a face, a voiceprint, a fingerprint, an iris, a vein, or the like. As the biometric information, data (feature amount) calculated from a physical feature unique to an individual such as a face or a voiceprint may be used as the feature information.

In this example embodiment, the authentication apparatus 100 performs face authentication of the user by using facial feature information of the user as the biometric information. The authentication apparatus 100 receives a face authentication request together with a face image of the user from the digital asset management apparatus 200, and performs the face authentication of the user. The authentication apparatus 100 returns the authentication result to the digital asset management apparatus 200, which is the request source.

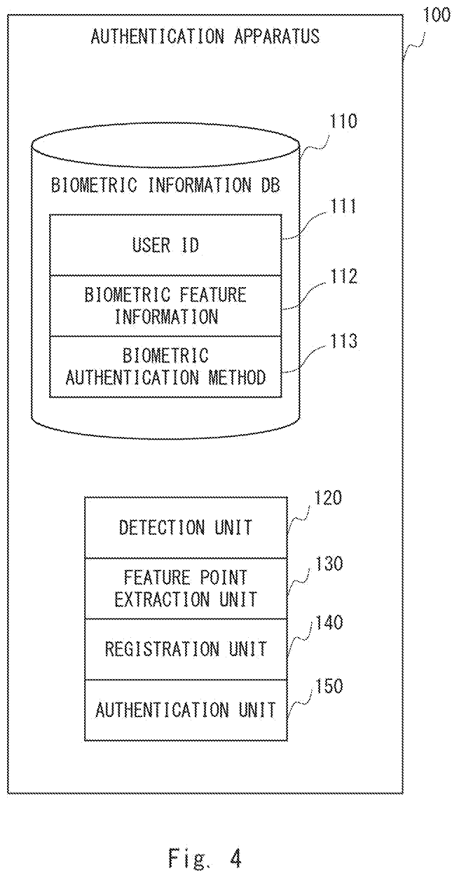

FIG. 4 is a block diagram illustrating a configuration of the authentication apparatus 100 according to this example embodiment. The authentication apparatus 100 includes a biometric information database (DB) 110, a detection unit 120, a feature point extraction unit 130, a registration unit 140, and an authentication unit 150.

The biometric information DB 110 stores a user ID 111, biometric feature information 112 of the user ID, and a biometric authentication method 113 in association with each other.

The user ID 111 is identification information for identifying the user.

The biometric feature information 112 is a feature amount calculated from a physical feature unique to the individual user. In this example embodiment, the biometric feature information 112 is a set of feature points extracted from a user's face image. Hereinafter, the biometric feature information 112 may be referred to as facial feature information.

The biometric authentication method 113 is an authentication method such as face authentication, voiceprint authentication, and fingerprint authentication. In this example embodiment, the biometric authentication method 113 is face authentication. In a case where the authentication apparatus 100 performs biometric authentication using a plurality of authentication methods, the biometric authentication method 113 may include a plurality of different authentication methods. The authentication apparatus 100 may perform the biometric authentication by using the biometric feature information 112 corresponding to a requested authentication method. Further, the authentication apparatus 100 may perform authentication using a plurality of authentication methods depending on a request.

The detection unit 120 detects a face region included in a registration image for registering facial feature information and outputs the face region to the feature point extraction unit 130.

The feature point extraction unit 130 extracts feature points from the face region detected by the detection unit 120 and outputs facial feature information to the registration unit 140.

Further, the feature point extraction unit 130 extracts feature points included in the face image or the like received from the digital asset management apparatus 200, and outputs facial feature information to the authentication unit 150.

The registration unit 140 newly issues the user ID 111 when registering the biometric feature information. The registration unit 140 registers the issued user ID 111 and the biometric feature information 112 extracted from the registration image in the biometric information DB 110 in association with each other.

The authentication unit 150 performs biometric authentication by using the biometric feature information 112. Specifically, the authentication unit 150 collates the facial feature information extracted from the face image with the biometric feature information 112 in the biometric information DB 110. In a case where the collation has succeeded, the authentication unit 150 specifies the user ID 111 associated with the collated biometric feature information 112.

The authentication unit 150 returns whether or not the pieces of biometric feature information match each other to the digital asset management apparatus 200 as a result of the biometric authentication. Whether or not the pieces of biometric feature information match with each other corresponds to whether or not authentication has succeeded or failed. Note that, a case where the pieces of biometric feature information match each other represents a case where the degree of matching is equal to or larger than a predetermined value. Further, in a case where the biometric authentication has succeeded, it is assumed that the biometric authentication result includes the specified user ID 111.

### (Face Information Registration Processing)

Next, face information registration processing according to this example embodiment will be described.

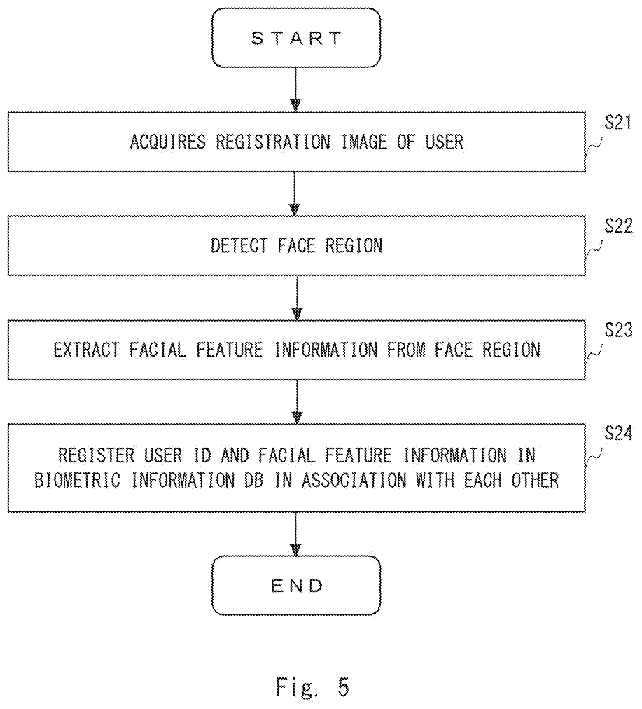

FIG. 5 is a flowchart illustrating a flow of face information registration processing according to this example embodiment. First, the authentication apparatus 100 acquires the registration image included in a face information registration request (S21). For example, the authentication apparatus 100 receives the face information registration request from the digital asset management apparatus 200, a registration website, or the like through the network N.

Next, the detection unit 120 detects a face region included in the registration image (S22). Next, the feature point extraction unit 130 extracts a feature point from the face region detected in step S22 and outputs biometric feature information 112 to the registration unit 140 (S23). Finally, the registration unit 140 issues the user ID 111, and registers the user ID 111 and the biometric feature information 112 in the biometric information DB 110 in association with each other (S24). The authentication apparatus 100 may receive the biometric feature information 112 from a communication terminal or the like possessed by the user and register the biometric feature information 112 and the user ID 111 in the biometric information DB 110 in association with each other.

### (Face Authentication Processing)

Next, a flow of the face authentication processing will be described.

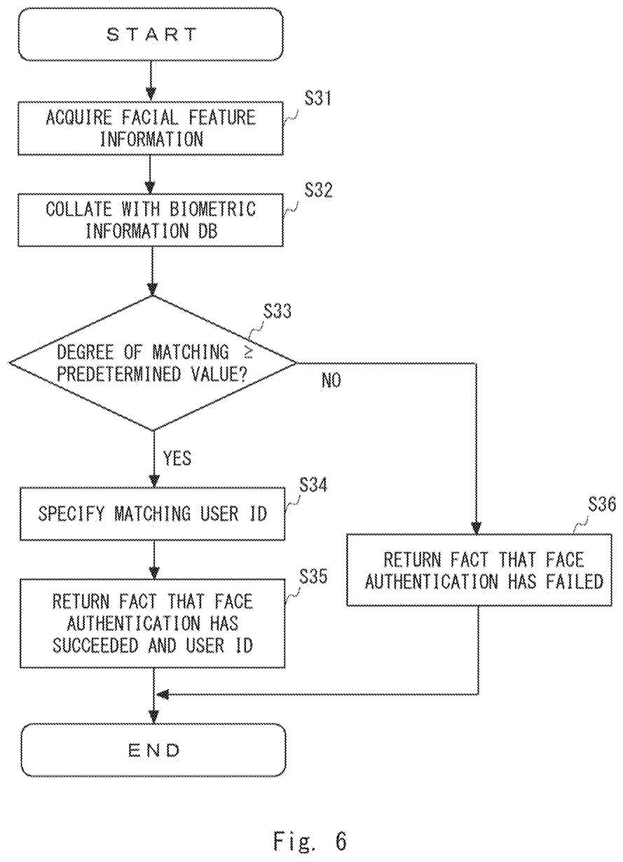

FIG. 6 is a flowchart illustrating a flow of face authentication processing by the authentication apparatus 100 according to this example embodiment.

First, the feature point extraction unit 130 acquires facial feature information included in a biometric authentication request (S31). For example, the authentication apparatus 100 receives the face authentication request from the digital asset management apparatus 200 through the network N, and extracts facial feature information from the face image included in the face authentication request as in steps S21 to S23.

Next, the authentication unit 150 collates the acquired facial feature information with the biometric feature information 112 in the biometric information DB 110 (S32). In a case where the pieces of facial feature information match each other, that is, the degree of matching between the pieces of facial feature information is equal to or larger than a predetermined value (YES in S33), the authentication unit 150 specifies the user ID 111 of the user whose facial feature information matches (S34). Then, the authentication unit 150 returns the fact that the face authentication has succeeded and the specified user ID 111 to the digital asset management apparatus 200 (S35). In a case where there is no matching facial feature information (NO in S33), the authentication unit 150 returns the fact that biometric authentication has failed to the digital asset management apparatus 200 (S36).

### (Digital Asset Management Apparatus 200)

Next, the digital asset management apparatus 200 will be described. The digital asset management apparatus 200 is an information processing apparatus that performs information processing for managing the digital asset of the user.

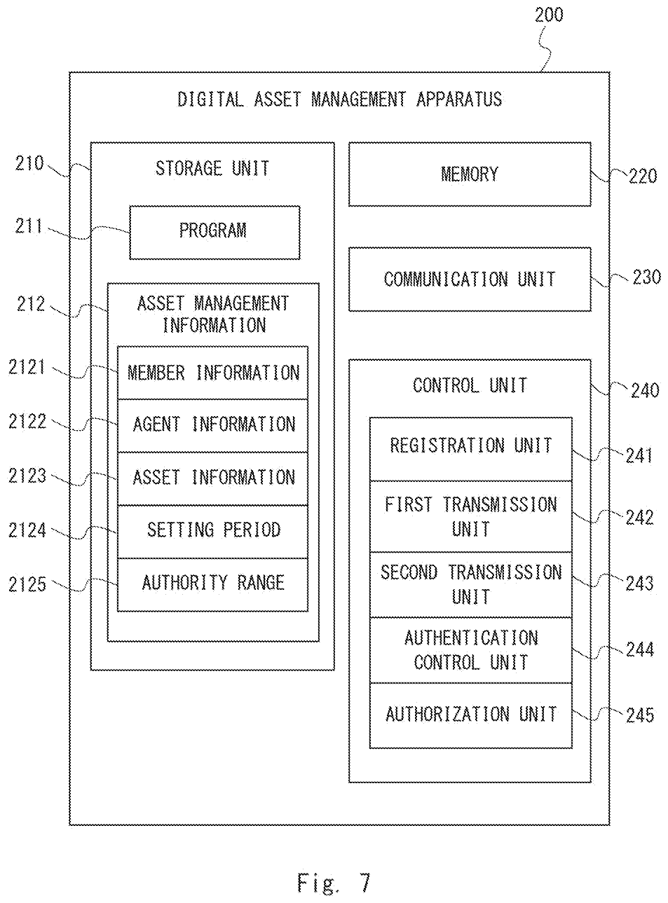

FIG. 7 is a block diagram illustrating a configuration of the digital asset management apparatus 200. The digital asset management apparatus 200 includes a storage unit 210, a memory 220, a communication unit 230, and a control unit 240.

The storage unit 210 is a storage apparatus such as a hard disk or a flash memory. The storage unit 210 stores a program 211 and asset management information 212.

The program 211 is a computer program in which the processing of the digital asset management method according to this example embodiment is implemented.

The asset management information 212 is information for managing the digital asset of the member. The asset management information 212 is information in which member information 2121, agent information 2122, asset information 2123, setting period 2124, and authority range 2125 are associated. For example, the asset management information 212 is registered by receiving input of a member via the registration screen 310a to be described below.

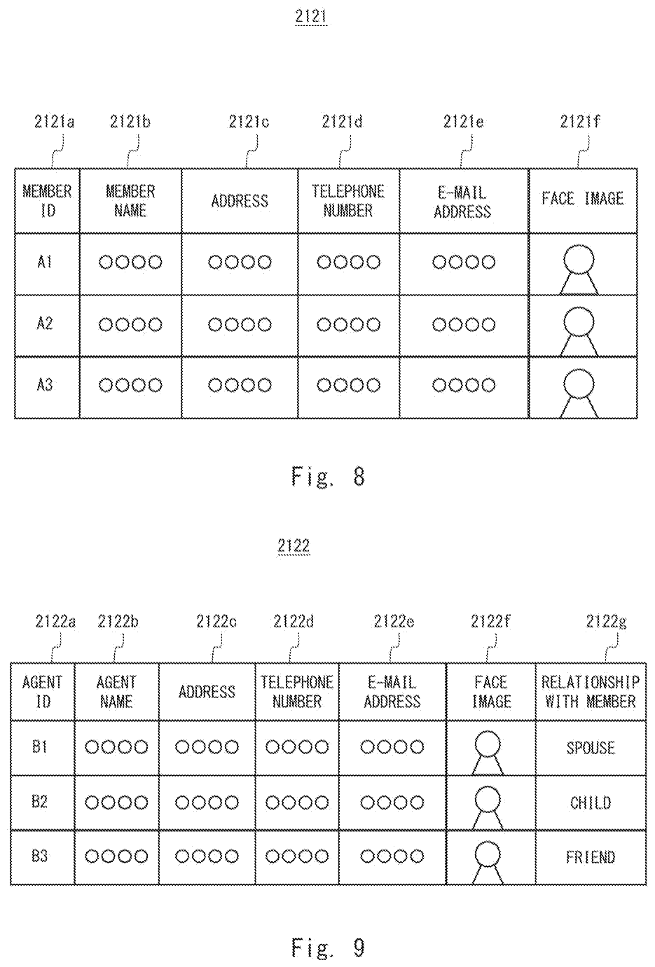

Hereinafter, the asset management information 212 will be described with reference to FIGS. 8 to 10 in addition to FIG. 7.

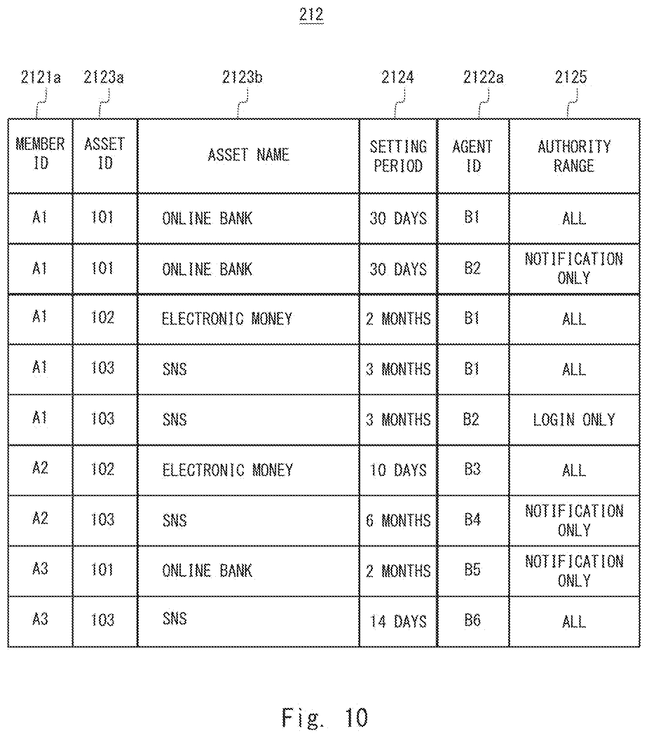

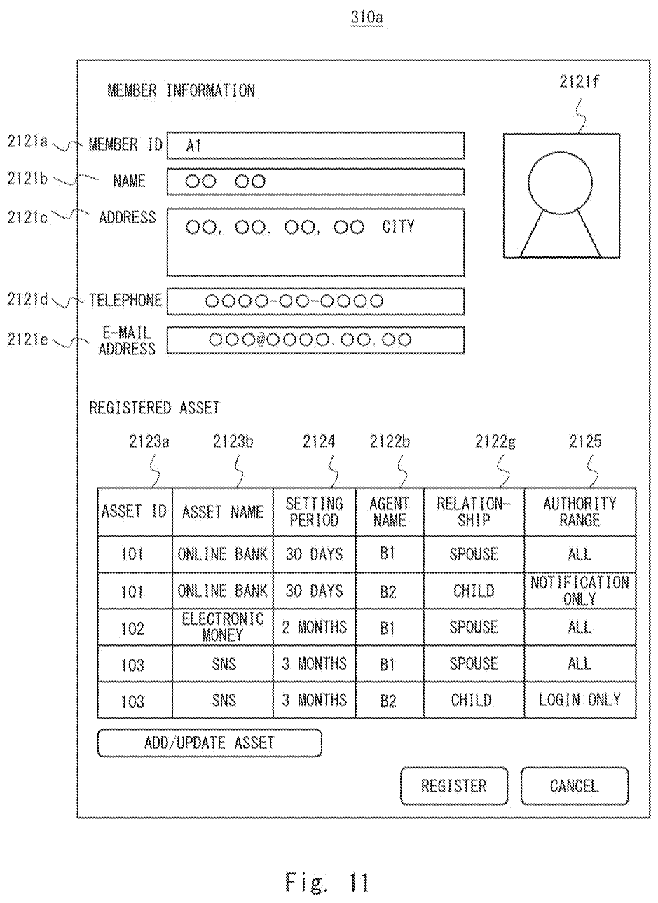

FIG. 8 is a diagram illustrating an example of the member information 2121. FIG. 9 is a diagram illustrating an example of the agent information 2122. FIG. 10 is a diagram illustrating an example of the asset management information 212.

The member information 2121 is information related to the member.

The member information 2121 will be described with reference to FIG. 8. The member information 2121 is, for example, information in which a member ID 2121a for identifying the member is associated with personal information of the member. The member ID 2121a is information corresponding to the user ID 111. The personal information of the member includes information for transmitting a confirmation notice from the digital asset management apparatus 200 to the communication terminal 300. The personal information of the member is, for example, name 2121b, address 2121c, telephone number 2121d, e-mail address 2121e, and face image 2121f of the member. Details of each piece of information will be described below.

Further, the member information 2121 may include biometric authentication information used for biometric authentication of the member. The biometric authentication information may include a biometric authentication method and biometric feature information. In this example embodiment, the biometric authentication information includes the facial feature information of the member as the biometric feature information. Note that, in this example embodiment, the facial feature information is stored in the biometric information DB 110 as the biometric feature information 112. The digital asset management apparatus 200 can refer to and manage the facial feature information of the member stored in the biometric information DB 110 via the member ID 2121a corresponding to the user ID 111 of the authentication apparatus 100. Accordingly, it can be said that the member information 2121 substantially includes the facial feature information of the member.

The agent information 2122 is information related to the agent.

The agent information 2122 is registered in association with the member information 2121. The agent information 2122 of a plurality of agents may be registered with respect to the member information 2121 of one member.

The agent information 2122 will be described with reference to FIG. 9. The agent information 2122 is, for example, information in which an agent ID 2122a for identifying the agent is associated with personal information of the agent. The agent ID 2122a is information corresponding to the user ID 111. The personal information of the agent includes information for transmitting an agent notice from the digital asset management apparatus 200 to the communication terminal 301 or 302. The personal information of the agent is, for example, name 2122b, address 2122c, telephone number 2122d, e-mail address 2122e, and face image 2122f of the agent. The agent information 2122 may include relationship 2122g with the member. The relationship 2122g with the member is, for example, information indicating a spouse, a child, a parent, a brother, a sister, a friend, or the like.

Further, similarly to the member information 2121, the agent information 2122 may include biometric authentication information used for biometric authentication of the agent. In this example embodiment, the biometric authentication information includes the facial feature information of the agent as the biometric feature information. The digital asset management apparatus 200 can refer to and manage the facial feature information of the agent stored in the biometric information DB 110 via the agent ID 2122a corresponding to the user ID 111 of the authentication apparatus 100. Accordingly, it can be said that the agent information 2122 substantially includes the facial feature information of the agent.

Returning to FIG. 7, the description will be continued.

The asset information 2123, the setting period 2124, and the authority range 2125 are information associated with the member information 2121 and the agent information 2122 described above for asset management.

The asset management information 212 will be specifically described with reference to FIG. 10. FIG. 10 is a diagram illustrating an example of the asset management information 212 including the asset information 2123, the setting period 2124, and the authority range 2125.

The asset information 2123 is information regarding the digital asset of the member.

The asset information 2123 is, for example, information in which an asset ID 2123a for identifying the asset is associated with an asset name 2123b indicating the content of the digital asset.

The setting period 2124 is information indicating a period until the confirmation notice is transmitted to the member.

The setting period 2124 is associated with the member ID 2121a and the asset ID 2123a. As the setting period 2124, an arbitrary period is set by receiving input of the member. The setting period 2124 may indicate the number of days (e.g., 30 days) or the number of months (e.g., 2 months) from the date and time when the account of the digital asset was last accessed. Further, the setting period 2124 may indicate a specific date and time (for example, hh/mm/dd/yyyy).

Different periods may be set for the setting period 2124 for each digital asset. For example, the member sets the setting period 2124 depending on the importance level of the digital asset. As the importance level of the asset increases, the setting period 2124 is set to be shorter, so that the period until the digital asset management apparatus 200 transmits the confirmation notice is shortened. Therefore, when it becomes difficult for the member to respond to the confirmation notice, the agent can quickly grasp the situation. Further, the member may set the setting period 2124 according to the frequency of access to the account. A similar effect can be obtained by setting the setting period 2124 to be short for an asset for which the access frequency is high.

The authority range 2125 is information indicating the range of authority given to the agent. The range of authority indicates, for example, the whole or a part of the authority related to the digital asset.

The authority range 2125 is associated with the member ID 2121a, the asset ID 2123a, and the agent ID 2122a. The authority range 2125 is set in an arbitrary range by receiving input from the member. The authority range 2125 may be set for each agent. For example, even for the same asset, different authority ranges 2125 may be set depending on agents. Further, the authority range 2125 may be set for each asset. For example, even for the same agent, different authority ranges 2125 may be set depending on assets.

A specific description will be given using the example illustrated in FIG. 10. A member whose member ID 2121a is “A1” is member A1, and agents whose agent IDs 2122a are “B1” and “B2” are agents B1 and B2, respectively. For the digital asset of the member A1, the agents B1 and B2 are set as agents of an “online bank” with an asset ID 2123a of “101”. An authority range 2125 of “all” is set for the agent B1, and an authority range 2125 of “notification only” is set for the agent B2. When the member A1 does not access the “online bank” for the setting period or more and does not respond to the confirmation notice, the agent confirmation is transmitted to the agents B1 and B2. When the agents B1 and B2 respond and the authentication is also successful, the agent B1 is authorized for “all” and the agent B2 is authorized for “notification only”.

In a case where the authority range 2125 is “all” like the agent B1, the digital asset management apparatus 200 gives the agent B1 all of the authority of the member A1. For example, the digital asset management apparatus 200 gives the agent B1 all the authority including the authority to use the ID and the password for accessing the bank account and the authority to manage the balance of the account. Further, when the authority range 2125 is “notification only” like the agent B2, the digital asset management apparatus 200 notifies the agent B2 that the digital asset is present. In this case, the digital asset management apparatus 200 notifies the agent B2 that the member A1 has an online bank account, but does not give the agent B2 the authority to use the ID, the password, or the like.

Note that, in the above description, as an example of the authority range 2125, “all” or “notification only” are used, but the setting of the authority range 2125 is not limited thereto. For example, the range of authority may be set for each more detailed item, such as “login only” in “SNS”.

Returning to FIG. 7, the description will be continued.

The memory 220 is a volatile storage apparatus such as random access memory (RAM), and is a storage area for temporarily holding information during the operation of the control unit 240.

The communication unit 230 is a communication interface with the network N.

The control unit 240 is a processor that controls each configuration of the digital asset management apparatus 200, that is, a control apparatus. The control unit 240 reads the program 211 from the storage unit 210 into the memory 220 and executes the program 211. As a result, the control unit 240 implements the functions of a registration unit 241, a first transmission unit 242, a second transmission unit 243, an authentication control unit 244, and an authorization unit 245.

The registration unit 241 corresponds to the registration unit 11 of the first example embodiment.

The registration unit 241 registers the member information 2121 of the member A1 having the account and the agent information 2122 of the agents B1 and B2 in the asset management information 212 in association with each other. Further, the registration unit 241 registers these pieces of information in the asset management information 212 in association with the asset information 2123, the setting period 2124, and the authority range 2125. That is, the registration unit 241 registers the asset management information 212 in association with a plurality of pieces of information used for managing the digital asset of the member A1.

The registration unit 241 can receive input from the communication terminal 300 via a registration website or the like and register the asset management information 212. For example, the member A1 inputs necessary items according to the registration screen 310a displayed on the display unit 310. The registration unit 241 receives input contents from the member A1 and registers the asset management information 212.

FIG. 11 is a diagram illustrating an example of the registration screen 310a for registering the asset management information 212. For example, the registration screen 310a includes a “member information” field for registering the member information 2121 and a “registered asset” field for registering the agent information 2122, the asset information 2123, the setting period 2124, and the authority range 2125.

The “member information” field includes the member ID 2121a, the name 2121b, the address 2121c, the telephone number 2121d, the e-mail address 2121e, and the face image 2121f. The member A1 inputs necessary items in each field using the communication terminal 300. Note that the member ID 2121a may be automatically numbered.

The e-mail address 2121e is, for example, an e-mail address that allows the communication terminal 300 to receive the confirmation notice transmitted from the digital asset management apparatus 200. Further, a plurality of e-mail addresses 2121e may be registered. It is not limited thereto, and for example, in a case where the confirmation notice is given by notification of a predetermined application or in a case where the confirmation notice is given by automatic voice to the telephone number 2121d, the e-mail address 2121e may not be essential.

The face image 2121f may be captured using a camera connected to the communication terminal 300 or a camera built in the communication terminal 300, or an image file captured in advance may be registered. When the member A1 uses the face authentication, the authentication apparatus 100 may extract the facial feature information from the face image 2121f and register the facial feature information in the biometric information DB 110.

The “asset information” field includes the asset ID 2123a, the asset name 2123b, the setting period 2124, the name 2122b of the agent, the relationship 2122g, and the authority range 2125. As in the “member information” field, the member A1 inputs necessary items in the “asset information” field. Note that the asset ID 2123a may be automatically numbered. As described above, the member A1 can set the agent information 2122, the setting period 2124, and the authority range 2125 for each asset with different contents.

Note that the agent information 2122 can be input by using a display screen similar to the “member information” field of the registration screen 310a, and thus illustration and detailed description thereof are omitted. The member A1 may input the name 2122b of the agent, the address 2122c, the telephone number 2122d, the e-mail address 2122e, the face image 2122f, and the relationship 2122g similarly to the member information 2121. Note that the agent B1 or B2 may input the agent information 2122.

Note that, at the time of registration of the agent, approval confirmation for confirming with the agent whether to approve the registration as an agent may be performed. For example, the registration unit 241 transmits an approval confirmation e-mail to the e-mail addresses 2122e of the agents B1 and B2, and registers the agent information 2122 of the agents B1 and B2 when receiving a reply indicating approval.

Note that the contents of the registration screen 310a are not limited to those illustrated in FIG. 11. For example, the “member information” field and the “registered asset” field may not be displayed on the same screen. Further, only a part of the display contents illustrated in FIG. 11 may be displayed, or other elements may be further displayed.

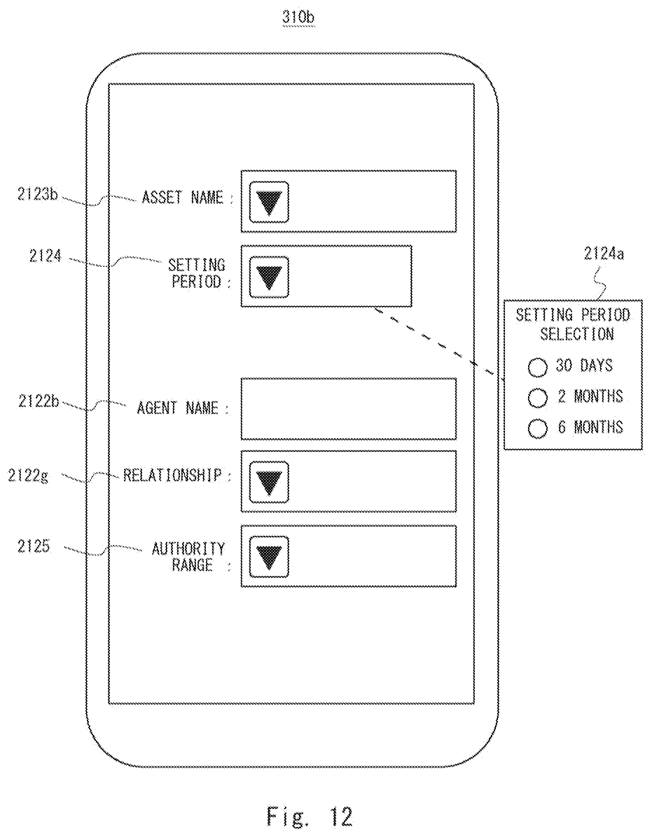

FIG. 12 is a diagram illustrating an example of another registration screen 310b for registering the asset management information 212. For example, the registration screen 310b includes input fields of the asset name 2123b, the setting period 2124, the agent name 2122b, the relationship 2122g, and the authority range 2125.

Each input field may be configured to enable direct input, as well as input in a pull-down format or a radio button format. The member can easily perform inputting by selecting a desired input content from a plurality of input candidates. As an example, the drawing illustrates a setting period selection area 2124a for inputting the setting period 2124 in a radio button format. The setting period selection area 2124a displays options of “30 days”, “2 months”, and “6 months”, and receives selection of any from the member. The setting period selection area 2124a may receive the input of the setting period 2124 by calendar display.

The setting period selection area 2124a may display different input candidates depending on the digital asset, the member, or the agent. For example, the setting period selection area 2124a displays a shorter period as a candidate as the value of the digital asset increases. As a result, the shorter setting period 2124 is more likely to be set as the asset value increases. The value of the digital asset may be determined based on the amount of money, or may be determined based on the importance level of the digital asset set by the member, or the like.

Further, on the registration screen 310b, when the agent name 2122b is input, the biometric information of the agent or a certificate of the agent's identity may be registered. Further, the agent may be notified of the fact that the user sets the agent, and the biometric information of the agent may be registered on the communication terminal of the agent. At this time, the agent may be requested to consent to become the agent.

### (Registration Processing of Asset Management Information)

The registration processing of the asset management information 212 performed by the digital asset management apparatus 200 will be described with reference to a flowchart. The registration processing of the asset management information 212 is processing of registering the member information 2121, the agent information 2122, the asset information 2123, the setting period 2124, and the authority range 2125 in association with each other. The digital asset management apparatus 200 receives input of the member A1 in the communication terminal 300 and registers the asset management information 212.

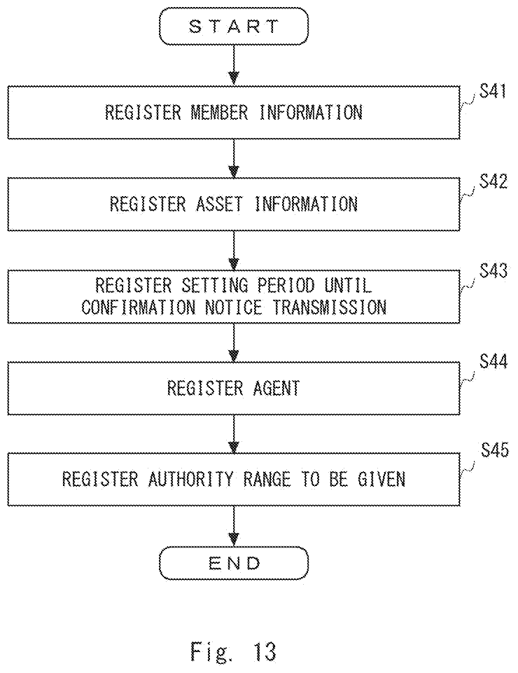

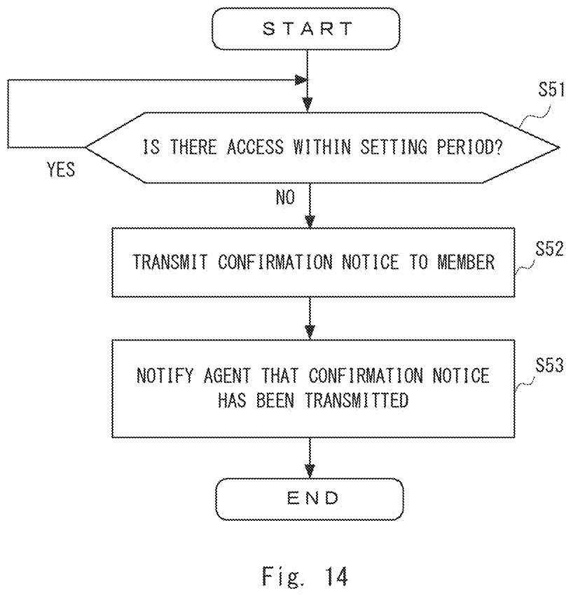

FIG. 13 is a flowchart illustrating registration processing of the asset management information 212.

First, the registration unit 241 registers the member information 2121 (S41). The member information 2121 may include the face image 2121f used for biometric authentication of the member A1. Next, the registration unit 241 registers the asset information 2123 in association with the member information 2121 (S42). Subsequently, the registration unit 241 registers the setting period 2124 until the confirmation notice transmission for each asset (S43). Different periods may be set for the setting period 2124 depending on the digital asset. Then, the registration unit 241 registers the agent information 2122 for each asset (S44). The agent information 2122 may include the face image 2122f used for biometric authentication of the agent. Further, the agent information 2122 of a plurality of agents may be registered with respect to the member information 2121 of one member. Finally, the registration unit 241 registers the authority range to be given to the agent for each agent (S45). The authority range to be given may vary depending on the agent. Further, the same agent may be given different authority ranges depending on the asset.

Note that the order of the processing is not limited to the above-described order. The processing may be performed in a different order as appropriate. Further, in a case where there is a plurality of agents or assets, the processing of steps S42 to S45 is appropriately repeated.

Returning to FIG. 7, the description of the control unit 240 will be continued.

The first transmission unit 242 corresponds to the first transmission unit 12 of the first example embodiment.

The first transmission unit 242 transmits a confirmation notice to the member when there is no access to the account for a setting period set by the member or more.

For example, in the example illustrated in FIG. 10, the member A1 sets the setting period 2124 as “30 days” for “online bank” with the asset ID of “101”. Accordingly, when the member A1 does not access the account of the online bank for 30 days or more, the first transmission unit 242 transmits a confirmation notice to the member A1.

The first transmission unit 242 determines whether the member A1 has accessed the account based on, for example, the presence or absence of login to the web service of the online bank. For example, the first transmission unit 242 acquires the last login date and time to the web service and measures the elapsed period. In a case where 30 days or more have elapsed without login, the first transmission unit 242 determines that the member A1 has not accessed the account for the setting period or more. In a case where login is performed again within 30 days, the first transmission unit 242 resets the elapsed period and measures the elapsed period from the last login date and time again. It is not limited thereto, and the first transmission unit 242 may determine that the member A1 has accessed by an application such as of a smartphone corresponding to the web service, or by using the balance of the online bank account or making a balance inquiry at an ATM or the like, or the like. The determination of the presence or absence of access to the account is not limited to the above. The first transmission unit 242 may determine the presence or absence of access to the account depending on the digital asset.

In a case where it is determined that there is no access for the setting period or more, the first transmission unit 242 refers to the member information 2121 and acquires the e-mail address 2121e (see FIG. 8) of the member A1. The first transmission unit 242 transmits a confirmation notice e-mail to the acquired e-mail address. The confirmation notice is a notice for confirming the status of the member A1. The confirmation notice may be, for example, an e-mail including a message “Member A1 has not accessed the account of oo bank for 30 days or more. Please reply to this e-mail for confirmation.”. The confirmation notice may request only a reply or may include an item for selecting the status of the member A1. The status of the member A1 may indicate, for example, contents such as “busy” and “poor physical condition”. Further, the confirmation notice may include a response deadline.

Note that the confirmation notice is not limited to an e-mail, and may be in any form. For example, the first transmission unit 242 may acquire the telephone number 2121d and give notification of the confirmation notice by using short message service (SMS), or may give a confirmation notice by automatic voice or the like. Further, the first transmission unit 242 may give a confirmation notice by push notification or the like via a predetermined application installed in the communication terminal 300.

In this example embodiment, the digital asset management apparatus 200 gives a confirmation notice or an agent notice by using an e-mail. Note that, in the following description, transmitting the confirmation notice e-mail to the e-mail address 2121e of the member A1 may be simply referred to as “transmitting the confirmation notice to the member A1”. Further, similarly, transmitting an agent notice e-mail to the e-mail addresses 2122e of the agents B1 and B2 may be referred to as unit “transmitting the agent notice to the agents B1 and B2”. Note that the same applies to the confirmation notice and the notice or notification of other than the agent.

The first transmission unit 242 may notify the agents B1 and B2 that the confirmation notice has been transmitted to the member A1. As a result, the agent B1 and the agent B2 can grasp that the member A1 has not accessed the account for the setting period or more. The first transmission unit 242 acquires the e-mail addresses 2122e of the agents B1 and B2 with reference to the agent information 2122, and transmits an e-mail indicating that the confirmation notice has been given. The e-mail may, for example, include a message such as “Member A1 has not accessed the account of oo bank for 30 days or more. A confirmation notice e-mail has been transmitted to member A1.”.

The second transmission unit 243 corresponds to the second transmission unit 13 of the first example embodiment.

The second transmission unit 243 transmits the agent notice to the agents B1 and B2 when there is no member response from the member A1 to the confirmation notice transmitted from the first transmission unit 242 to the e-mail address of the member A1. The member response indicates a response of the member A1 to the confirmation notice. For example, when a reply e-mail to the confirmation notice is received from the member A1, the second transmission unit 243 determines that there is a member response. The agent notice is to notice the agent that there is no response from the member A1. The agent notice may be, for example, an e-mail including a message such as “There is no response from member A1. Please replay to this e-mail.”.

In a case where there is no member response within a predetermined period (for example, one day) after the confirmation e-mail is transmitted, the second transmission unit 243 transmits the above-described agent notice. Similarly to the setting period 2124, the predetermined period may be set for each asset or agent after receiving input from the member A1, or an arbitrary period may be automatically set. The second transmission unit 243 acquires the e-mail addresses 2122e of the agents B1 and B2 with reference to the agent information 2122, and transmits an agent notice to the agents B1 and B2.

Note that the second transmission unit 243 may notify the member A1 that the agent notice is transmitted before transmission of the agent notice. For example, the second transmission unit 243 transmits a message such as “A notice that there is no response of member A1 is given to agent B1 and agent B2.” to the e-mail address of the member A1. As a result, in a case where the member A1 simply forgets to perform the member response, or the like, it is possible not to give the agent notice to the agents B1 and B2.

Further, the second transmission unit 243 may notify the member A1 that there is an agent response from the agent B1 or B2 in response to the agent notice. The agent response indicates a response of the agent B1 or B2 with respect to the agent notice. For example, when a reply e-mail to the agent notice is received from the agent B1 or B2, the second transmission unit 243 determines that there is an agent response. The second transmission unit 243 transmits, for example, an e-mail including a message such as “There was a response from agent B1.” to the e-mail address of the member A1. As a result, even when the member A1 is not aware of the confirmation notice and the notification of transmitting the agent notice, the member A1 can grasp that there is a response from the agent B1 or B2.

Further, in a case where there is a member response from the member A1 in response to the confirmation notice to the member A1, the second transmission unit 243 may notify the agents B1 and B2 that there is a member response from the member A1. The second transmission unit 243 transmits, for example, a message such as “There was a response from member A1.” to the e-mail addresses of the agents B1 and B2. As a result, the agents B1 and B2 can confirm that the member A1 is in a situation of being capable of response. Further, since the confirmation notice timing and the confirmation response timing can be grasped, the agents B1 and B2 can grasp the time from when the member A1 receives the confirmation notice to when the confirmation response is transmitted. As a result, it is possible to grasp that the member A1 quickly responds or it takes time to respond.

Note that the first transmission unit 242 and the second transmission unit 243 can confirm the status of the agent by transmitting the agent confirmation notice to the agents B1 and B2, similarly to the confirmation of the status of the member A1 described above. The agent confirmation notice is a notice for confirming the status of the agents B1 and B2. The agent confirmation notice may be transmitted at any timing. By transmitting an agent confirmation notice periodically (for example, every three months), the status of the agent can be confirmed.

Specifically, first, the first transmission unit 242 transmits an agent confirmation notice to the agent. The agent confirmation notice may be, for example, an e-mail including a message such as “Please reply to this e-mail for confirmation of the status of agent B1.”. In a case where there is no response to the agent confirmation notice from the agent B1 or B2, the second transmission unit 243 notifies the member A1 that there is no response to the agent confirmation notice. The notification to the member A1 may be, for example, an e-mail including a message such as “Agent confirmation notice was transmitted to agent B1, but there is no response.”. As a result, since the member A1 can grasp the status of the agents B1 and B2, the member A1 can consider addition or change of the agent according to the status.

The authentication control unit 244 corresponds to the authentication control unit 14 of the first example embodiment.

The authentication control unit 244 controls authentication of the agent when there is an agent response from the agent in response to the agent notice. The authentication control unit 244 controls authentication so as to perform personal authentication of the agent using biometric authentication, two-step authentication, or the like. In this example embodiment, the authentication control unit 244 controls face authentication of the agent. As described above, the agent information 2122 includes the facial feature information of the agent used for face authentication of the agent. Further, the digital asset management apparatus 200 can refer to and manage the facial feature information of the agent stored in the biometric information DB 110 via the agent ID 2122a corresponding to the user ID 111.

The authentication control unit 244 receives a face authentication request including the face image of the agent B1 or B2 via the communication terminal 301 or 302. The authentication control unit 244 transmits the face authentication request including the face image of the agent B1 or B2 to the authentication apparatus 100. The authentication control unit 244 receives a result of the face authentication from the authentication apparatus 100.

The authorization unit 245 corresponds to the authorization unit 15 of the first example embodiment.

When the authentication of the agent B1 or B2 is successful, the authorization unit 245 refers to the asset management information 212 and gives the agent B1 or B2 the authority related to the digital asset of the member A1.

In the example of FIG. 10 described above, the member A1 sets the authority range of “all” for the agent B1, who is a spouse, and sets the authority range of “notification only” for the agent B2, who is a child. Accordingly, when the agent B1 is successfully authenticated, the authorization unit 245 gives the agent B1 all the authority related to the digital asset “online bank”. For example, the authorization unit 245 gives, to the agent B1, notification of the existence of the account, disclosure of the ID and the password, disclosure of the content of the digital asset, guidance of the transfer procedure or continuous use of the account, and the like. For example, the authorization unit 245 transmits the information related to the above to the e-mail address of the agent B1. As a result, the agent B1 can access the digital asset “online bank” of the member A1 using the disclosed ID and password. The agent B1 can manage the digital asset of the member A1 on behalf of the member A1.

Further, in a case where the agent B2 is successfully authenticated, the authorization unit 245 gives the agent B2 the authority to receive the notification of the existence of the account. For example, the authorization unit 245 transmits information for notifying the agent B2 of the existence of the account to the e-mail address of the agent B2. As a result, the agent B2 can grasp the existence of the digital asset “online bank” of the member A1.

### (Digital Asset Management Processing)

Next, processing performed by the digital asset management apparatus 200 will be described with reference to flowcharts illustrated in FIGS. 14 to 16.

FIG. 14 is a flowchart illustrating confirmation notice transmission processing of transmitting a confirmation notice to the member A1.

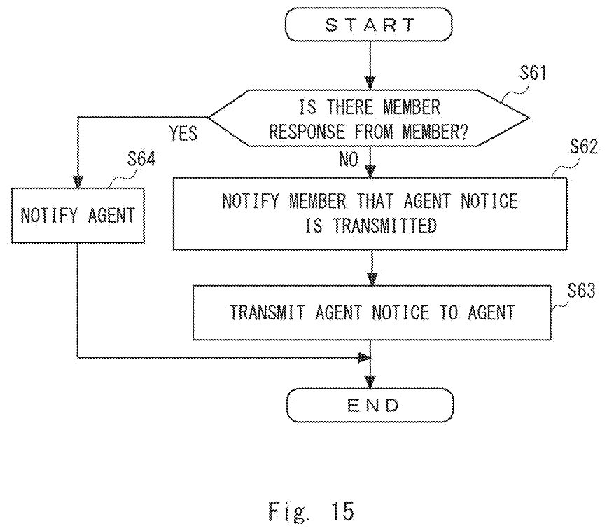

FIG. 15 is a flowchart illustrating agent notice transmission processing of transmitting an agent notice to the agents B1 and B2.

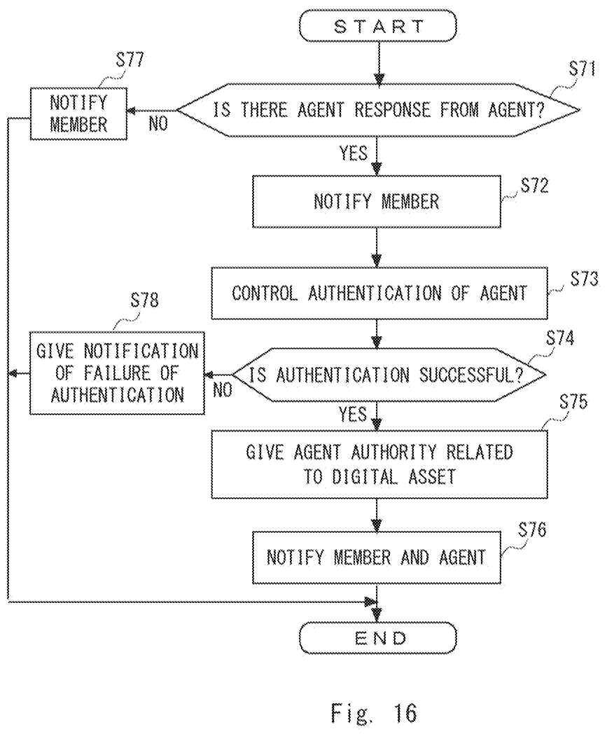

FIG. 16 is a flowchart illustrating authentication control processing and authorization processing for the agents B1 and B2.

Note that the following description will be made with reference to FIGS. 7 to 10 together.

First, the confirmation notice transmission processing will be described with reference to FIG. 14.

The first transmission unit 242 refers to the asset management information 212 and acquires the setting period 2124 set by the member A1 associated with the digital asset. The first transmission unit 242 determines whether the member A1 has accessed the account for the setting period or more (S51). When there is an access (YES in S51), the processing of step S51 is repeated. When there is no access (NO in S51), the first transmission unit 242 refers to the asset management information 212 and acquires the e-mail address 2121e of the member A1. The first transmission unit 242 transmits a confirmation notice to the acquired e-mail address of the member A1 (S52). The first transmission unit 242 acquires the e-mail addresses 2122e of the agents B1 and B2, and transmits the fact that the confirmation notice has been transmitted to the respective e-mail addresses (S53). Note that, similarly in the following processing, each functional unit of the digital asset management apparatus 200 acquires the e-mail address of the member A1 or the like with reference to the asset management information 212. Hereinafter, redundant description will be omitted.

Next, the agent notice transmission processing will be described with reference to FIG. 15.

The second transmission unit 243 determines whether or not there is a member response from the member A1 within a predetermined period (S61). When there is a member response from the member A1 (YES in S61), the second transmission unit 243 notifies the agents B1 and B2 that there is a member response from the member A1 (S64), and ends the processing.

When there is no member response from the member A1 (NO in S61), the second transmission unit 243 notifies the member A1 that an agent notice is transmitted (S62). The second transmission unit 243 transmits an agent notice to the agent B1 or B2 (S63). Note that, in a case where there is a response from the member A1 before transmitting the agent notice, the processing ends without transmitting the agent notice.

Next, the authentication control processing and the authorization processing will be described with reference to FIG. 16.

The second transmission unit 243 determines whether or not there is an agent response from the agent B1 or B2 (S71). When there is no agent response from either of the agents B1 and B2 (NO in S71), the second transmission unit 243 notifies the member A1 of that fact (S77), and ends the processing.

When there is an agent response from the agent B1 or B2 (YES in S71), the second transmission unit 243 notifies the member A1 of that fact (S72). Here, it is assumed that there is an agent response from each of the agents B1 and B2. The authentication control unit 244 receives an authentication request from the agent B1 or B2 via the communication terminal 301 or 302, and controls authentication of the agent B1 or B2 (S73). Here, the authentication control unit 244 receives a face authentication request including the face image of the agent B1 or B2 and transmits the face authentication request to the authentication apparatus 100. The authentication control unit 244 receives a result of the face authentication from the authentication apparatus 100.

The authorization unit 245 determines whether the authentication of the agent B1 or B2 is successful (S74). When the authentication fails (NO in S74), the authorization unit 245 does not give the agent B1 or B2 the authority, gives notification of the failure of authentication (S78), and ends the processing. When the authentication is successful (YES in S74), the authorization unit 245 gives the agent B1 or B2 the authority related to the digital asset of the member A1 (S75). Here, it is assumed that the agents B1 and B2 have succeeded in the face authentication. The authorization unit 245 refers to the asset management information 212 and gives the agents B1 and B2 the authority according to the set authority range 2125. For example, the authorization unit 245 gives the agent B1 all of the authority and gives the agent B2 a part of the authority. The authorization unit 245 notifies the member A1 and the agents B1 and B2 that the authority of the digital asset has been given to the agents B1 and B2 (S76), and ends the processing.

Note that the digital asset management apparatus 200 may perform agent notice processing for confirming the status of the agent at an arbitrary timing.

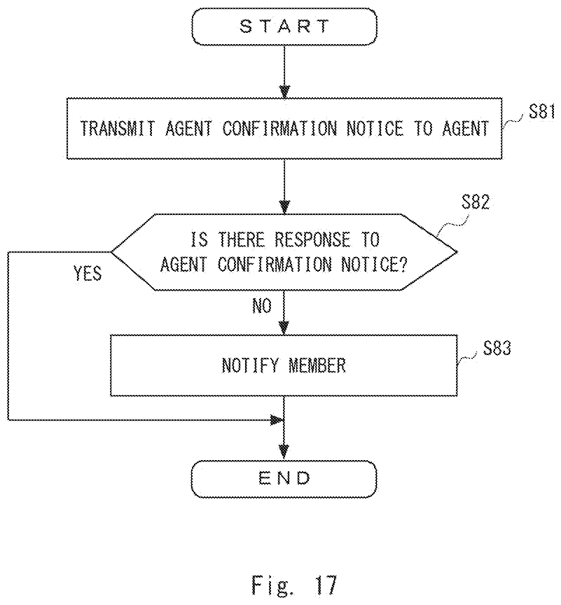

FIG. 17 is a flowchart illustrating the agent confirmation processing.

The first transmission unit 242 transmits an agent confirmation notice to the agents B1 and B2 (S81). The second transmission unit 243 determines whether or not there is a response from the agent B1 or B2 in response to the agent confirmation notice (S82). When there is a response (YES in S82), the processing ends. When there is no response (NO in S82), the second transmission unit 243 notifies the member A1 that there is no response to the agent confirmation notice (S83). Note that, in a case where there is a response from the agent B1 or B2 in step S82 (YES in S82), the second transmission unit 243 may notify the member A1 of that fact.

As described above, in the digital asset management system 1000 according to this example embodiment, in the digital asset management apparatus 200, the registration unit 241 registers the agent information of the agent with respect to the member information of the member having the account. The first transmission unit 242 transmits a confirmation notice to the member when there is no access to the account for a setting period set by the member or more. The second transmission unit 243 transmits an agent notice to the agent when there is no member response from the member in response to the confirmation notice. The authentication control unit 244 controls authentication of the agent when there is an agent response from the agent in response to the agent notice. In a case where the authentication of the agent is successful, the authorization unit 245 gives the agent the authority related to the digital asset of the member.

In this way, even when it becomes difficult for the member to manage the digital asset, it is possible to prevent the digital asset from being left in the absence of the manager. Further, in the digital asset management apparatus 200, the setting period until transmission of the confirmation notice can be set to a different period depending on the digital asset. As a result, it is possible to give a confirmation notice to the member in an appropriate period according to the access frequency and the importance level of the asset.

Then, in the digital asset management apparatus 200, since a plurality of agents can be set for one member, it is possible to have setting of giving different authorities depending on the agent. As a result, the asset can be transferred according to the relationship between the member and the agent. For example, the range of authority can be set to be gradually reduced in the order of a spouse, a child, and a friend.

Furthermore, since the digital asset management apparatus 200 notifies the agent that the confirmation notice has been transmitted to the member and that there has been a member response from the member, it is possible to appropriately notice the agent even in a situation where the member is capable of response. In this way, the agent does not grasp the status of the member only after the member cannot respond, but can grasp the status in advance. Thus, for example, it is possible to quickly grasp a change such as a delay in response of the member. As a result, asset transfer reflecting the intention of the member is facilitated between the member and the agent.

Further, in the digital asset management apparatus 200, by giving the agent confirmation notice to the agent, the member can grasp whether or not the agent is in a situation of being capable of response. As a result, even in a case where it is difficult to transfer the asset to the agent, the member can respond quickly. Further, in the digital asset management system 1000, the authentication apparatus 100 can also perform biometric authentication, so that the personal authentication of the agent can be strictly performed before the agent is authorized.

Note that, the configuration of the digital asset management system 1000 illustrated with reference to FIG. 3 is merely an example. Each of the authentication apparatus 100, the digital asset management apparatus 200, the communication terminal 300, the communication terminal 301, and the communication terminal 302 may be configured by using an apparatus in which a plurality of configurations is integrated, or respective functional units may be subjected to distributed processing by using a plurality of apparatuses. For example, the functions of the authentication apparatus 100 and the digital asset management apparatus 200 may be integrated in the same apparatus.

### Configuration Example of Hardware

Each functional component of the authentication apparatus 100, the digital asset management apparatus 200, the communication terminal 300, the communication terminal 301, and the communication terminal 302 may be achieved by hardware (for example, a hard-wired electronic circuit or the like) that achieves each functional component, or may be achieved by a combination of hardware and software (for example, a combination of an electronic circuit and a program that controls the electronic circuit, or the like). Hereinafter, a case where each functional component of the authentication apparatus 100 and the like is achieved by a combination of hardware and software will be further described.

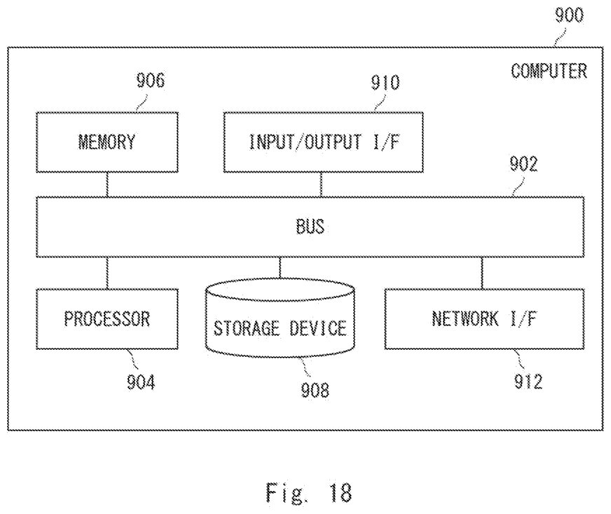

FIG. 18 is a block diagram illustrating a hardware configuration of a computer 900 that implements the authentication apparatus 100 or the like. The computer 900 may be a dedicated computer designed to achieve the authentication apparatus 100 or the like, or may be a general-purpose computer. The computer 900 may be a portable computer such as a smartphone and a tablet terminal.

For example, by installing a predetermined application in the computer 900, each function of the authentication apparatus 100 or the like is achieved in the computer 900. The application described above is configured by a program for achieving the functional components of the authentication apparatus 100 or the like.

The computer 900 includes a bus 902, a processor 904, a memory 906, a storage device 908, an input/output interface 910, and a network interface 912. The bus 902 is a data transmission path for the processor 904, the memory 906, the storage device 908, the input/output interface 910, and the network interface 912 to transmit and receive data to and from each other. However, a method of connecting the processor 904 and the like to each other is not limited to the bus connection.

The processor 904 is a variety of processors such as a central processing unit (CPU), a graphics processing unit (GPU), and a field-programmable gate array (FPGA). The memory 906 is a main storage apparatus realized by using a random access memory (RAM) or the like. The storage device 908 is an auxiliary storage apparatus realized by using a hard disk, a solid state drive (SSD), a memory card, a read only memory (ROM), or the like.

The input/output interface 910 is an interface for connecting the computer 900 and an input/output device. For example, an input apparatus such as a keyboard and an output apparatus such as a display apparatus are connected to the input/output interface 910.

The network interface 912 is an interface for connecting the computer 900 to a network. The network may be a local area network (LAN) or may be a wide area network (WAN).

The storage device 908 stores a program (program for achieving the above-described application) for achieving each functional component of the authentication apparatus 100 or the like. The processor 904 achieves each functional component of the authentication apparatus 100 or the like by reading and executing this program in the memory 906.

Each of the processors executes one or more programs including a command group for causing a computer to perform the algorithm described with reference to the drawings. The program includes a command group (or software codes) for causing the computer to perform one or more functions that have been described in the example embodiments when the program is read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage device. The program may be transmitted on a transitory computer-readable medium or a communication medium. As an example and not by way of limitation, the transitory computer-readable medium or the communication medium includes propagated signals in electrical, optical, acoustic, or any other form.

Note that the present disclosure is not limited to the above example embodiments, and can be appropriately changed without departing from the scope and spirit

Some or all of the above-described example embodiments can be described as in the following Supplementary Notes, but are not limited to the following Supplementary Notes.

### (Supplementary Note 1)

A digital asset management apparatus including:
registration means for registering agent information of an agent with respect to member information of a member having an account;
first transmission means for transmitting a confirmation notice to the member in a case where there is no access to the account for a setting period set by the member or more;
second transmission means for transmitting an agent notice to the agent in a case where there is no member response from the member in response to the confirmation notice;
authentication control means for controlling authentication of the agent in a case where there is an agent response from the agent in response to the agent notice; and
authorization means for giving the agent authority related to a digital asset of the member when the authentication is successful.

### (Supplementary Note 2)

The digital asset management apparatus according to Supplementary Note 1, in which the setting period varies depending on the digital asset.

### (Supplementary Note 3)

The digital asset management apparatus according to Supplementary Note 1 or 2, in which the agent information of a plurality of the agents is registered with respect to member information of one member.

### (Supplementary Note 4)

The digital asset management apparatus according to Supplementary Note 3, in which the authority varies depending on the agent.

### (Supplementary Note 5)

The digital asset management apparatus according to any one of Supplementary Notes 1 to 4, in which the agent is notified that the confirmation notice has been transmitted.

### (Supplementary Note 6)

The digital asset management apparatus according to any one of Supplementary Notes 1 to 5, in which the agent is notified that there is the member response.

### (Supplementary Note 7)

The digital asset management apparatus according to any one of Supplementary Notes 1 to 6, in which the member is notified that there is the agent response.

### (Supplementary Note 8)

The digital asset management apparatus according to any one of Supplementary Notes 1 to 7, in which an agent confirmation notice is transmitted to the agent, and the member is notified that there is no response to the agent confirmation notice when there is no response to the agent confirmation notice.

### (Supplementary Note 9)

The digital asset management apparatus according to any one of Supplementary Notes 1 to 8, in which the agent information includes biometric authentication information used for biometric authentication.

### (Supplementary Note 10)

The digital asset management apparatus according to any one of Supplementary Notes 1 to 9, in which the member is notified that the agent notice is transmitted after the confirmation notice is transmitted and before the agent notice is transmitted.

### (Supplementary Note 11)

A digital asset management system including:
an authentication apparatus; and
a digital asset management apparatus,
in which the digital asset management apparatus includes
registration means for registering agent information of an agent with respect to member information of a member having an account;
first transmission means for transmitting a confirmation notice to the member in a case where there is no access to the account for a setting period set by the member or more;
second transmission means for transmitting an agent notice to the agent in a case where there is no member response from the member in response to the confirmation notice;
authentication control means for controlling authentication of the agent with respect to the authentication apparatus in a case where there is an agent response from the agent in response to the agent notice; and
authorization means for giving the agent authority related to a digital asset of the member when the authentication is successful.

### (Supplementary Note 12)

The digital asset management system according to Supplementary Note 11, in which the setting period varies depending on the digital asset.

### (Supplementary Note 13)

A digital asset management method including:
registering agent information of an agent with respect to member information of a member having an account;
transmitting a confirmation notice to the member in a case where there is no access to the account for a setting period set by the member or more;
transmitting an agent notice to the agent in a case where there is no member response from the member in response to the confirmation notice;
controlling authentication of the agent in a case where there is an agent response from the agent in response to the agent notice; and
giving the agent authority related to a digital asset of the member when the authentication is successful.

### (Supplementary Note 14)

A non-transitory computer-readable medium storing a program causing a computer to execute:
registration processing of registering agent information of an agent with respect to member information of a member having an account;
first transmission processing of transmitting a confirmation notice to the member in a case where there is no access to the account for a setting period set by the member or more;
second transmission processing of transmitting an agent notice to the agent in a case where there is no member response from the member in response to the confirmation notice;
authentication control processing of controlling authentication of the agent in a case where there is an agent response from the agent in response to the agent notice; and
authorization processing of giving the agent authority related to a digital asset of the member when the authentication is successful.

### REFERENCE SIGNS LIST

10 DIGITAL ASSET MANAGEMENT APPARATUS
11 REGISTRATION UNIT
12 FIRST TRANSMISSION UNIT
13 SECOND TRANSMISSION UNIT
14 AUTHENTICATION CONTROL UNIT
15 AUTHORIZATION UNIT
100 AUTHENTICATION APPARATUS
110 BIOMETRIC INFORMATION DB
111 USER ID
112 BIOMETRIC FEATURE INFORMATION (FACIAL FEATURE INFORMATION)
120 DETECTION UNIT
130 FEATURE POINT EXTRACTION UNIT
140 REGISTRATION UNIT
150 AUTHENTICATION UNIT
200 DIGITAL ASSET MANAGEMENT APPARATUS
210 STORAGE UNIT
211 PROGRAM
212 ASSET MANAGEMENT INFORMATION
2121 MEMBER INFORMATION
2121a MEMBER ID
2121b NAME
2121c ADDRESS
2121d TELEPHONE NUMBER
2121e E-MAIL ADDRESS
2121f FACE IMAGE
2122 AGENT INFORMATION
2122a AGENT ID
2122b NAME
2122c ADDRESS
2122d TELEPHONE NUMBER
2122e E-MAIL ADDRESS
2122f FACE IMAGE
2122g RELATIONSHIP
2123 ASSET INFORMATION
2123a ASSET ID
2123b ASSET NAME
2124 SETTING PERIOD
2124a SETTING PERIOD SELECTION AREA
2125 AUTHORITY RANGE
220 MEMORY
230 COMMUNICATION UNIT
240 CONTROL UNIT
241 REGISTRATION UNIT
242 FIRST TRANSMISSION UNIT
243 SECOND TRANSMISSION UNIT
244 AUTHENTICATION CONTROL UNIT
245 AUTHORIZATION UNIT
300, 301, 302 COMMUNICATION TERMINAL
310, 311, 312 DISPLAY UNIT
310a, 310b REGISTRATION SCREEN
900 COMPUTER
902 BUS
904 PROCESSOR
906 MEMORY
908 STORAGE DEVICE
910 INPUT/OUTPUT INTERFACE
912 NETWORK INTERFACE
1000 DIGITAL ASSET MANAGEMENT SYSTEM
A1 MEMBER
B1, B2 AGENT
N NETWORK

What is claimed is:

1. A digital asset management apparatus comprising:
at least one memory storing instructions; and
at least one processor configured to execute the instructions to:
register agent information of an agent with respect to member information of a member having an account;
transmit a confirmation notice to the member in a case where there is no access to the account for a setting period set by the member or more;
transmit an agent notice to the agent in a case where there is no member response from the member in response to the confirmation notice;
control authentication of the agent in a case where there is an agent response from the agent in response to the agent notice; and
give the agent authority related to a digital asset of the member when the authentication is successful.

2. The digital asset management apparatus according to claim 1, wherein the setting period varies depending on the digital asset.

3. The digital asset management apparatus according to claim 1, wherein the agent information of a plurality of the agents is registered with respect to member information of one member.

4. The digital asset management apparatus according to claim 3, wherein the authority varies depending on the agent.

5. The digital asset management apparatus according to claim 1, wherein the agent is notified that the confirmation notice has been transmitted.

6. The digital asset management apparatus according to claim 1, wherein the agent is notified that there is the member response.

7. The digital asset management apparatus according to claim 1, wherein the member is notified that there is the agent response.

8. The digital asset management apparatus according to claim 1, wherein an agent confirmation notice is transmitted to the agent, and the member is notified that there is no response to the agent confirmation notice when there is no response to the agent confirmation notice.

9. The digital asset management apparatus according to claim 1, wherein the agent information includes biometric authentication information used for biometric authentication.

10. The digital asset management apparatus according to claim 1, wherein the member is notified that the agent notice is transmitted after the confirmation notice is transmitted and before the agent notice is transmitted.

11-12. (canceled)

13. A digital asset management method comprising:
registering agent information of an agent with respect to member information of a member having an account;
transmitting a confirmation notice to the member in a case where there is no access to the account for a setting period set by the member or more;
transmitting an agent notice to the agent in a case where there is no member response from the member in response to the confirmation notice;
controlling authentication of the agent in a case where there is an agent response from the agent in response to the agent notice; and
giving the agent authority related to a digital asset of the member when the authentication is successful.

14. A non-transitory computer-readable medium storing a program causing a computer to execute:
registration processing of registering agent information of an agent with respect to member information of a member having an account;
first transmission processing of transmitting a confirmation notice to the member in a case where there is no access to the account for a setting period set by the member or more;
second transmission processing of transmitting an agent notice to the agent in a case where there is no member response from the member in response to the confirmation notice;
authentication control processing of controlling authentication of the agent in a case where there is an agent response from the agent in response to the agent notice; and
authorization processing of giving the agent authority related to a digital asset of the member when the authentication is successful.
